(19) United States
(12) Patent Application Publication
(10) Pub. No.: US 2023/0336647 A1
(43) Pub. Date: Oct. 19, 2023

(54) ELECTRONIC DEVICE INCLUDING AN ANTENNA

(71) Applicant: SAMSUNG ELECTRONICS CO., LTD., Suwon-si (KR)

(72) Inventors: Moohyun Baek, Suwon-si (KR); Gyeongtae Kim, Suwon-si (KR)

(73) Assignee: SAMSUNG ELECTRONICS CO., LTD., Suwon-si (KR)

(21) Appl. No.: 18/213,067

(22) Filed: Jun. 22, 2023

Related U.S. Application Data
(63) Continuation of application No. PCT/KR2021/013532, filed on Oct. 1, 2021.

(30) Foreign Application Priority Data
Dec. 22, 2020 (KR) 10-2020-0181077

(51) Int. Cl. H04M 1/02

(52) U.S. Cl. CPC H04M 1/0249; H04M 1/0277

(57) ABSTRACT

An electronic device includes a communication module; a printed circuit board (PCB) provided with the communication module; and a housing supporting the PCB, and including an inner supporter made of a conductive material and an outer casing supporting the inner supporter. The inner supporter includes: a main body made of a conductive sheet; a bridge extended from an outer edge of the main body in a certain direction; at least one antenna radiator extended from the bridge along an outer edge of the housing; a contact portion provided from the at least one antenna radiator and facing toward an inside of the housing; and a connecting member made of a non-conductive material and fixing the at least one antenna radiator.

This application is a continuation of international application PCT/KR2021/013532 filed on Oct. 1, 2021 in the Korean Intellectual Property Office and claims priority to Korean Patent Application No. 10-2020-0181077 filed on Dec. 22, 2020 in the Korean Intellectual Property Office; the disclosures of the above applications are incorporated by reference herein in their entireties.

### FIELD

The disclosure relates to an electronic device, and more particularly to an electronic device with an antenna.

### BACKGROUND

An electronic device supporting wireless communication includes an antenna. In a mobile electronic device such as a smart phone or a tablet computer, a metal material disposed inside the electronic device or forming an outer appearance of the electronic device is employed as a radiator, thereby transceiving a signal of a specific frequency band.

Meanwhile, the electronic device includes a supporting structure to hold a printed circuit board (PCB) mounted with a communication module and the like therein. To form the supporting structure, aluminum (Al) alloy, magnesium (Mg) alloy or the like casting material is heated to a temperature higher than its melting point, and the liquid of the melted material is poured into and hardened in a casing.

### SUMMARY

According to the disclosure, a supporting structure of an electronic device includes an antenna radiator formed by extending a casting material along an outer edge in upper and lower ends thereof. The antenna radiator is in contact with a communication module of a PCB by a contact such as a C-clip. The antenna radiator formed by such a casting is relatively simple and has good rigidity, but may require high manufacturing costs.

The disclosure provides an electronic device including an antenna excellent in rigidity while requiring low manufacturing costs.

According to an embodiment of the disclosure, there is provided an electronic device. The electronic device includes a communication module; a printed circuit board (PCB) provided with the communication module; and a housing supporting the PCB, and including an inner supporter made of a conductive material and an outer casing supporting the inner supporter. The inner supporter includes: a main body made of a conductive sheet; a bridge extended from an outer edge of the main body in a certain direction; at least one antenna radiator extended from the bridge along an outer edge of the housing; a contact portion provided from the at least one antenna radiator and facing toward an inside of the housing; and a connecting member made of a non-conductive material and fixing the at least one antenna radiator.

At least one among the bridge, the antenna radiator and the contact portion may be formed by bending a strap extended outwards from the outer edge of the main body.

The antenna radiator may be extended being bent perpendicularly to a sheet surface of the main body.

The contact portion may be formed by transforming a sheet surface of the antenna radiator to protrude toward the main body.

The contact portion may protrude from a sheet surface of the antenna radiator toward the main body and may be bent to have a sheet surface parallel to the sheet surface of the antenna radiator.

Each of the two or more antenna radiators may be provided with a first coupling unit, and the connecting member may include a second coupling unit coupled to the two or more first coupling units.

The first coupling unit may be fused to the second coupling unit in a process of insert-injection molding the inner supporter into the outer casing.

One of the first coupling unit and the second coupling unit may include a pair of protrusions spaced apart from each other, and the other one of the first coupling unit and the second coupling unit may include a coupling groove to accommodate the pair of protrusions by forcible fitting.

One of the first coupling unit and the second coupling unit may include a hook, and the other one of the first coupling unit and the second coupling unit may include a hook holder to which the hook is hooked.

The connecting member may be made of a transparent material, and the first coupling unit may be fused to the second coupling unit by a laser.

The first coupling unit may be bonded to the second coupling unit by adhesive.

According to an embodiment of the disclosure, there is provided an electronic device. The electronic device includes: a housing including an inner supporter made of a conductive material and an outer casing supporting the inner supporter. The inner supporter includes: a main body made of a conductive sheet; a bridge extended from an outer edge of the main body in a certain direction; at least one antenna radiator extended from the bridge along an outer edge of the housing; a contact portion provided from the at least one antenna radiator and facing toward an inside of the housing; and a connecting member made of a non-conductive material and fixing the at least one antenna radiator.

According to an embodiment of the disclosure, there is provided a method of manufacturing an electronic device. The method of manufacturing an electronic device includes: manufacturing an inner supporter made of a conductive material; and manufacturing a housing by insert-injection molding of the inner supporter into an outer casing made of an insulating material. The manufacturing the inner supporter includes: preparing a sheet of conductive material; manufacturing an unfolded sheet of the inner supporter on the sheet to include a main body sheet and at least one strap extended outwards from the main body sheet; and forming at least one antenna assembly by bending the strap in multiple steps.

The strap may include an antenna strap.

The strap may include a contact portion strap extended from the antenna strap, and the method may further include forming a contact portion to have a sheet surface perpendicular to a sheet surface of the main body sheet by bending the contact portion strap to protrude toward the main body sheet.

The manufacturing the inner supporter may include manufacturing an antenna radiator shaped like a cantilever by bending the antenna strap to have a sheet surface perpendicular to the sheet surface of the main body sheet.

The manufacturing the inner supporter may include fixing a free end portion of the antenna radiator to the connecting member.

The manufacturing the inner supporter may include forming a contact portion by bending the antenna radiator to protrude toward the main body sheet.

The connecting member and the antenna radiator may be fused together by heat applied during the insert-injection molding.

The connecting member and the antenna radiator may be fused together by a laser beam.

Provided herein is an electronic device including: a communication module; a printed circuit board (PCB) provided with the communication module; and a housing supporting the PCB, and including an inner supporter made of a conductive material and an outer casing supporting the inner supporter, the inner supporter including: a main body made of a conductive sheet, a bridge extended from a first outer edge of the main body in a certain direction, at least one antenna radiator extended from the bridge along a second outer edge of the housing, a contact portion provided from the at least one antenna radiator and facing toward an inside of the housing, and a connecting member made of a non-conductive material and fixing the at least one antenna radiator.

Also provided herein is an electronic device including: a housing including an inner supporter made of a conductive material and an outer casing supporting the inner supporter, the inner supporter including: a main body made of a conductive sheet, a bridge extended from a first outer edge of the main body in a certain direction, at least one antenna radiator extended from the bridge along a second outer edge of the housing, a contact portion provided from the at least one antenna radiator and facing toward an inside of the housing, and a connecting member made of a non-conductive material and fixing the at least one antenna radiator.

Also provided herein is a method of manufacturing an electronic device, the method including: manufacturing an inner supporter made of a conductive material; and manufacturing a housing by an insert-injection molding of the inner supporter into an outer casing made of an insulating material, the manufacturing the inner supporter including: preparing a sheet of conductive material, manufacturing an unfolded sheet of the inner supporter on the sheet, wherein the unfolded sheet includes a main body sheet and at least one strap extended outwards from the main body sheet, and forming at least one antenna assembly by bending the at least one strap in multiple steps.

As described above, in the electronic device according to the disclosure, the inner supporter to be insert-injection molded into the outer casing is formed with the antenna radiator by bending a sheet material with a progressive mold, thereby reducing manufacturing costs. Further, the antenna radiator shaped like a cantilever is fixed by the connecting member of the non-conductive material, and thus prevented from being opened or curved due to injection pressure during the insert-injection molding.

### BRIEF DESCRIPTION OF THE DRAWINGS

Other aspects, features and advantages of the disclosure will become more apparent from the following detailed description, taken in conjunction with the accompanying drawings.

FIG. 1 is a view illustrating an outer appearance of an electronic device according to an embodiment.

FIG. 2 is an exploded view of an electronic device according to an embodiment.

FIG. 3 is a view illustrating an outer casing and an inner supporter according to an embodiment.

FIG. 4 is a view illustrating a housing injection-molded by inserting an inner supporter in an outer casing according to an embodiment.

FIG. 5 is a cross-sectional view taken along line B-B in FIG. 4 according to an embodiment.

FIG. 6 is a cross-sectional view of a first antenna assembly, taken along line A-A in FIG. 2, according to an embodiment

FIG. 7 is a cross-sectional view of a second antenna assembly according to an embodiment, taken along line A-A in FIG. 2.

FIG. 8 is a view illustrating that a PCB and a battery are mounted to a housing according to an embodiment.

FIG. 9 is a view illustrating a first antenna assembly of FIG. 3 according to an embodiment.

FIG. 10 is a view illustrating a coupling structure of a first antenna according to an embodiment.

FIG. 11 is a view illustrating the second antenna assembly of FIG. 3 according to an embodiment.

FIG. 12 is a view illustrating an unfolded sheet for forming a first antenna assembly according to an embodiment.

FIG. 13 is a view illustrating a state that the unfolded sheet of FIG. 12 is first bent according to an embodiment.

FIG. 14 is a view illustrating the first antenna assembly formed by second bending from the state of FIG. 13 according to an embodiment.

FIG. 15 is a view illustrating a coupling structure of an antenna radiator according to an embodiment.

FIG. 16 is a view illustrating a bonding structure of an antenna radiator according to an embodiment.

FIG. 17 is a cross-sectional view of describing a laser bonding process for a connecting member of FIG. 16 according to an embodiment.

FIG. 18 is a view illustrating a coupling structure for an antenna radiator according to an embodiment.

FIG. 19 is a view illustrating a state that a connecting member is applied to an insert injection mold according to an embodiment.

FIG. 20 is a view illustrating a coupling structure for an antenna radiator according to an embodiment.

FIG. 21 is a view illustrating an antenna assembly according to an embodiment.

FIG. 22 is a view illustrating a state that first to third C-clips are in contact with first to third contact portions of the antenna assembly of FIG. 21.

FIG. 23 is a flowchart showing a method of manufacturing a housing of an electronic device according to an embodiment.

FIG. 24 is a block diagram of an electronic device in a network environment according to embodiments.

### DETAILED DESCRIPTION

Below, various embodiments of the disclosure will be described in detail with reference to the accompanying drawings. However, it should be appreciated that the disclosure is not limited to specific embodiments but include various modifications, equivalents and/or alternatives to such embodiments. In the drawings, like numerals or symbols refer to like elements having substantially the same function, and the size of each element may be exaggerated for clarity and convenience of description. In the following descriptions, details about publicly known technologies or configurations may be omitted if they unnecessarily obscure the gist of the disclosure.

In the disclosure, terms “have,” “may have,” “include,” “may include,” etc. indicate the presence of corresponding features (e.g., a numeral value, a function, an operation, or an element such as a part, etc.), and do not exclude the presence of additional features.

In the disclosure, terms “A or B”, “at least one of A or/and B”, “one or more of A or/and B” or the like may include all possible combinations of elements enumerated together. For example, “A or B”, “at least one of A and B”, or “at least one of A or B” may refer to all of the cases of (1) including at least one A, (2) including at least one B, or (3) including all of at least one A and at least one B.

In the disclosure, terms “first”, “second”, etc. are used only to distinguish one element from another, and singular forms are intended to include plural forms unless otherwise mentioned contextually.

In addition, in the disclosure, terms “upper”, “lower”, “left”, “right”, “inside”, “outside”, “inner”, “outer”, “front”, “rear”, etc. are defined with respect to the accompanying drawings, and do not restrict the shape or location of the elements.

Further, in the disclosure, the expression of “configured to (or set to)” may for example be replaced with “suitable for,” “having the capacity to,” “designed to,” “adapted to,” “made to,” or “capable of” according to circumstances. The term “configured to (or set to)” may not mean only “specifically designed to” in hardware. Instead, the expression “a device configured to” may mean that the device is “capable of” operating together with another device or other parts.

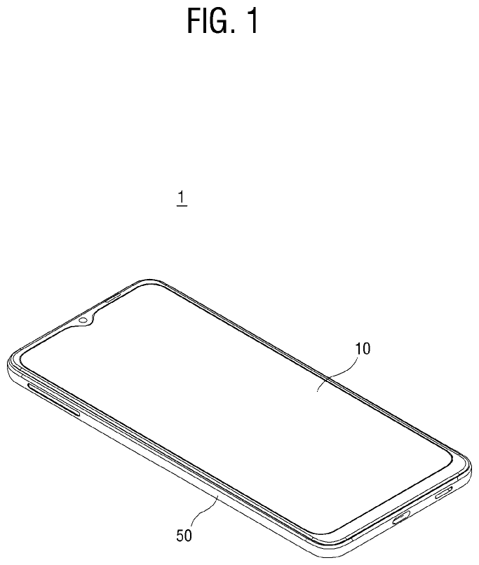

FIG. 1 is a view illustrating an outer appearance of an electronic device 1 according to an embodiment.

According to an embodiment, an electronic device 1 may, for example, include a user mobile device, such as a smart phone, a tablet computer, and a smart note. The electronic device 1 may be shaped like a kind of rectangular parallelepiped having a certain volume, or may have a shape similar to the rectangular parallelepiped. For example, the front and back surfaces of the electronic device 1 may be flat, and all or some of the four lateral sides (e.g., two left and right lateral surfaces) of the electronic device 1 may have an arbitrary curvature for better grip.

In the embodiment shown in FIG. 1, the electronic device 1 may include a cover window 10 and a housing 50. According to an embodiment, the front cover window 10 may be bent at one side of the electronic device 1. For example, the cover window 10 may be bent at left or right lateral edge of the electronic device 1.

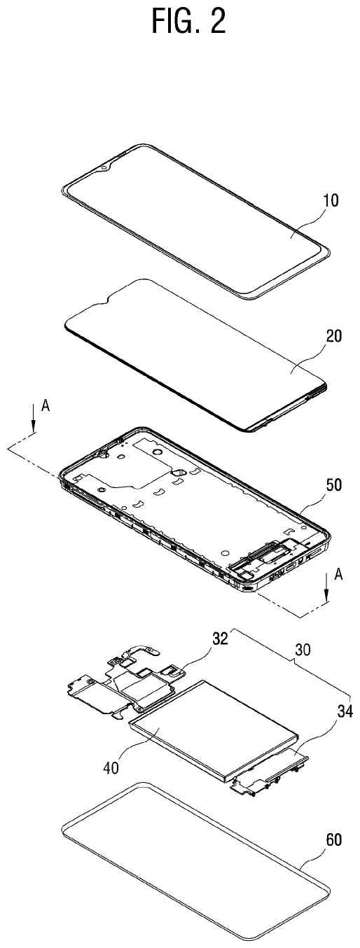

FIG. 2 is an exploded view of the electronic device 1 according to an embodiment.

As shown in FIG. 2, a display panel 20 may be provided beneath the front cover window 10 of the electronic device 1. The display panel 20 may have a shape corresponding to the cover window 10. For example, the display panel 20 may be implemented as a flexible or transformable display panel to have a shape corresponding to the cover window 10.

According to an embodiment, a conductive plate (e.g., a copper sheet) implemented as a conductive member may be disposed beneath the display panel 20 to cut off noise when the display is operating. The conductive plate may also be implemented with its partial surface thereof being partially attached to or integrated into the display panel 20.

The housing 50 is shaped like a rectangular box, thereby supporting the cover window 10 and the display panel 20 at one side thereof and supplying a printed circuit board (PCB) 30 and a battery 40 at the other side thereof.

According to an embodiment, the PCB 30 may be mounted with electrical components such as an application processor (AP), a memory, a communication module, a power management module, and various sensors. The communication module may for example include modules for short-range communication such as Bluetooth or infrared data association (IrDA), and modules for long-range communication such as legacy cellular, 5^{th} generation (5G), next generation communication, Wi-Fi, a local area network, and a wide area network. The PCB 30 may include a main PCB 32 and a sub PCB 34.

The battery 40 may supply power to at least one element of the electronic device 1. According to an embodiment, the battery 40 may, for example, include a non-rechargeable primary battery, a rechargeable secondary battery, or a fuel cell.

According to an embodiment, a back cover 60 may be disposed on the back of the housing 50. The back cover 60 may form a back outer appearance of the electronic device 1.

The electronic device 1 may further include a lateral cover forming a lateral outer appearance.

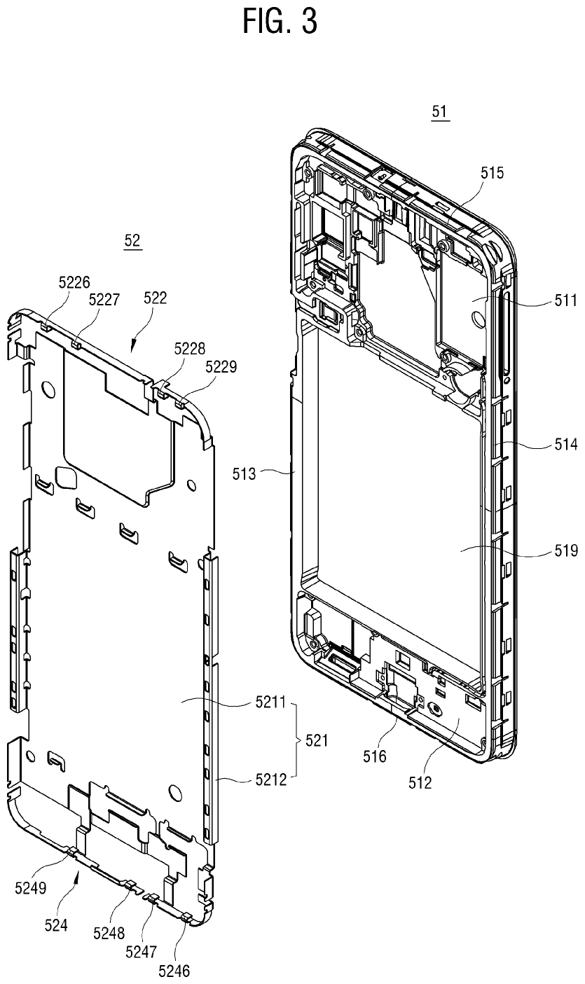

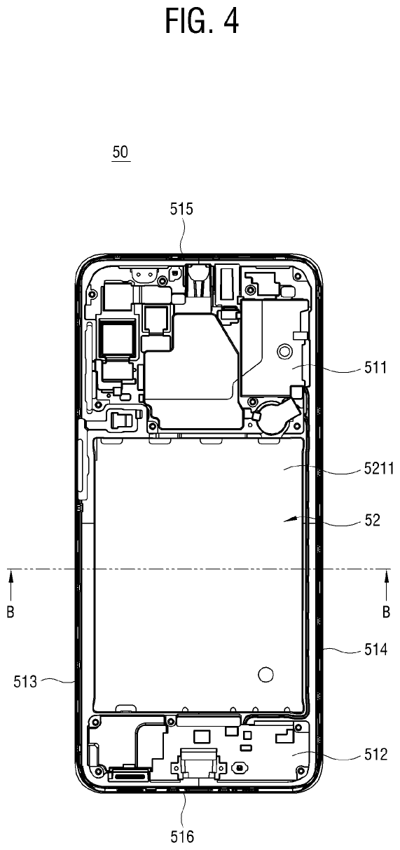

The housing 50 of the electronic device 1 may be designed to be as thin as possible according to slimming trend. In this case, if the housing 50 is manufactured by injection molding using only a nonmetallic material such as a polymer-based polycarbonate reinforced with 10% glass fibers (PC GF 10%), the strength of the housing 50 is too low to be durable. Accordingly, the housing 50 may be manufactured by insert-injection molding of an inner supporter 52 (see FIG. 4) made of a conductive metallic material such as aluminum alloy, magnesium alloy, or iron alloy into an outer casing 51 (see FIG. 3) made of PC GF 10%, thereby increasing the strength of the housing 50.

Below, a process of manufacturing the housing 50 will be described with reference to FIGS. 3 to 7.

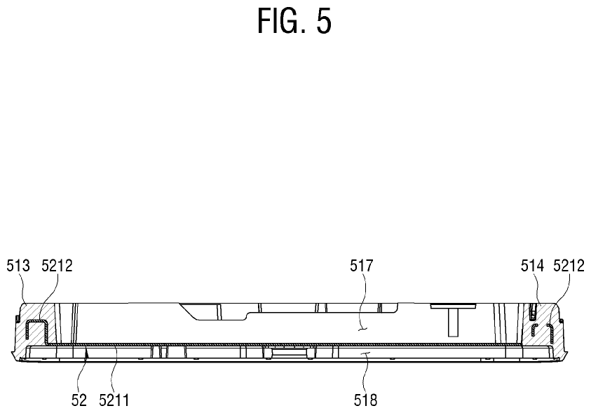

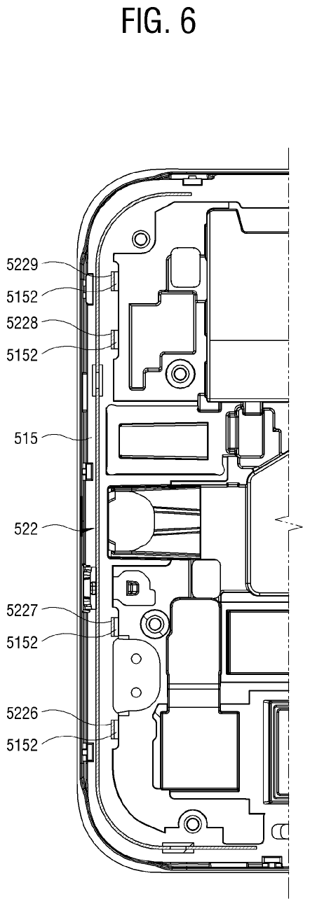

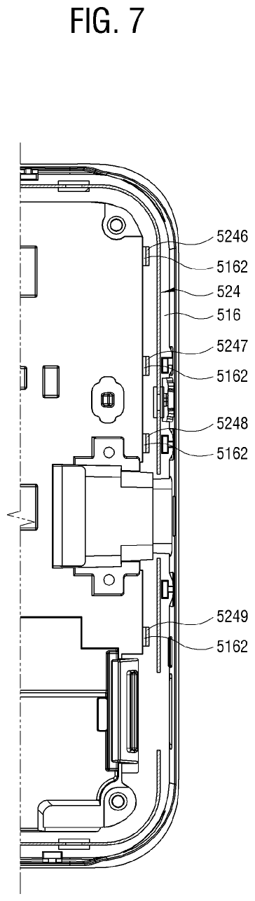

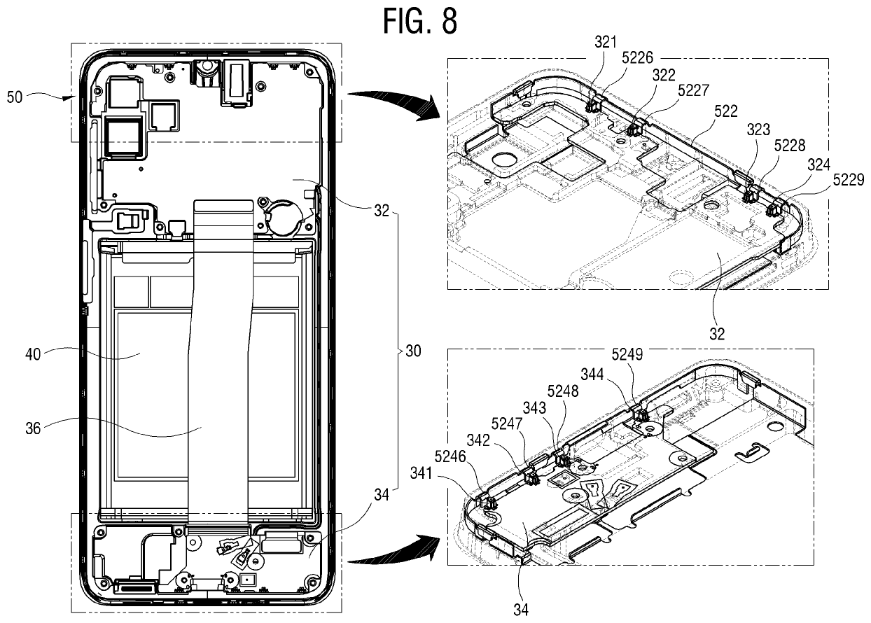

FIG. 3 is a view illustrating the outer casing 51 and the inner supporter 52 according to an embodiment, FIG. 4 is a view illustrating the housing 50 injection-molded by inserting the inner supporter 52 in the outer casing 51, FIG. 5 is a cross-sectional view taken along line B-B in FIG. 4, FIG. 6 is a cross-sectional view of a first antenna assembly 522, taken along line A-A in FIG. 2, FIG. 7 is a cross-sectional view of a second antenna assembly 524 according to an embodiment, taken along line A-A in FIG. 2, and FIG. 8 is a view illustrating that the PCB 30 and the battery 40 are mounted to the housing 50 according to an embodiment.

As shown in FIG. 3, the outer casing 51 may include a first bottom 511 provided at an upper side to install the main PCB 32 (see FIG. 2), a second bottom 512 provided at a lower side to install the sub PCB 34 (see FIG. 2), a left wall 513, a right wall 514, an upper wall 515, and a lower wall 516. The outer casing 51 includes an opening 519 between the first bottom 511 and the second bottom 512. As shown in FIG. 4, a main body 521 of the inner supporter 52 may include a bottom supporter 5211 exposed through the opening 519 during the insert-injection molding of the inner supporter 52.

The inner supporter 52 may be manufactured by pressing a sheet of a conductive material against a progressive mold. The inner supporter 52 may include the main body 521, the first antenna assembly 522 provided in an upper portion of the main body 521, and the second antenna assembly 524 provided in a lower portion of the main body 521.

The main body 521 includes the bottom supporter 5211 forming the bottom of the housing 50, and a lateral supporter 5212 supporting left and right sides.

The first antenna assembly 522 is extended leaving a gap from the upper outer edge of the main body 521. The first antenna assembly 522 may include first to fourth contact portions 5226 to 5229 protruding toward the main body 521.

The second antenna assembly 524 is extended leaving a gap from the lower outer edge of the main body 521. The second antenna assembly 524 may include fifth to eighth contact portions 5246 to 5249 protruding toward the inside of the main body 521.

The detailed structures of the first antenna assembly 522 and the second antenna assembly 524 will be described later.

As shown in FIG. 4, the inner supporter 52 made of the conductive material may be insert-injection molded into the outer casing 51 of the non-conductive material.

As shown in FIG. 5, the main body 521 of the inner supporter 52 may be disposed to divide the inside of the outer casing 51 into a first space 517 and a second space 518. The PCB 30 and the battery 40 of FIG. 2 may be accommodated and disposed in the first space 517 of the outer casing 51. The display panel 20 of FIG. 2 may be accommodated and disposed in the second space 518 of the outer casing 51.

The lateral supporter 5212 of the main body 521 may be positioned inside the left wall 513 and the right wall 514 of the outer casing 51.

As shown in FIG. 6, the first antenna assembly 522 of the inner supporter 52 may be positioned inside the upper wall 515 of the outer casing 51. In this case, the first to fourth contact portions 5226 to 5229 of the first antenna assembly 522 may be exposed through first openings 5152 provided inside the upper wall 515 of the outer casing 51.

As shown in FIG. 7, the second antenna assembly 524 of the inner supporter 52 may be supported on the lower wall 516 of the outer casing 51. In this case, the fifth to eighth contact portions 5246 to 5249 of the second antenna assembly 524 may be exposed through second openings 5162 provided inside the lower wall 516 of the outer casing 51.

As shown in FIG. 8, the main PCB 32, the sub PCB 34, and the battery 40 may be mounted to the inside of the first space 517 (see FIG. 5) of the housing 50.

The main PCB 32 and the sub PCB 34 may be respectively mounted to an upper portion and a lower portion of the first space 517 (see FIG. 5) of the housing 50. The battery 50 may be disposed between the main PCB 32 and the sub PCB 34. The main PCB 32 and the sub PCB 34 may be connected by a FPCB cable 36.

The main PCB 32 may include first to fourth C-clips 321 to 324. The sub PCB 34 may include fifth to eighth C-clips 341 to 344. The first to eighth C-clips 321 to 324 and 341 to 344 may be connected to at least one communication module positioned in the main PCB 32 and the sub PCB 34.

The first to fourth C-clips 321 to 324 mounted to the main PCB 32 may be in contact with the first to fourth contact portions 5226 to 5229 of the first antenna assembly 522 through the first openings 5152 (see FIG. 6), respectively. In this way, the first antenna assembly 522 may receive or radiate communication signals of the communication modules, for example, Bluetooth, Wi-Fi direct, infrared data association (IrDA) and the like short-range communication modules, provided in the main PCB 32.

The fifth to eighth C-clips 341 to 344 mounted to the sub PCB 34 may be in contact with the fifth to eighth contact portions 5246 to 5249 of the second antenna assembly 524 through the second openings 5162 (see FIG. 7), respectively. In this way, the second antenna assembly 524 may receive or radiate communication signals of, for example, legacy cellular, the 5^{th} generation (5G), the next generation communication, Wi-Fi, a local area network (LAN), a wide area network (WAN), a global positioning system (GPS), and the like long-range communication modules.

According to an embodiment, the main PCB 32 and the sub PCB 34 may also be mounted to the lower portion and the upper portion of the housing 50, respectively. Alternatively, one of them may be provided in the center, and the other one may be provided in the upper or lower portion.

According to an embodiment, the first to fourth C-clips 321 to 324 mounted to the main PCB 32 and the fifth to eighth C-clips 341 to 344 mounted to the sub PCB 34 are not limited to being respectively disposed toward the upper and lower ends of the housing 50, but may be disposed toward the left or right side. In this case, the first to fourth contact portions 5226 to 5229 of the first antenna assembly 522 and the fifth to eighth contact portions 5246 to 5249 of the second antenna assembly 524 may be each provided in the left or right side of the housing 50.

Further, the first to fourth contact portions 5226 to 5229 of the first antenna assembly 522 and the fifth to eighth contact portions 5246 to 5249 of the second antenna assembly 524 may be used individually or shared by various communication modules.

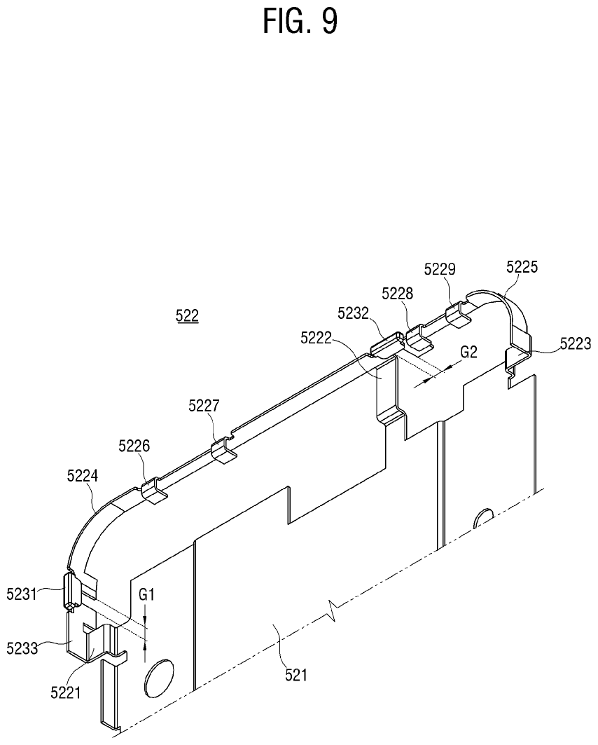

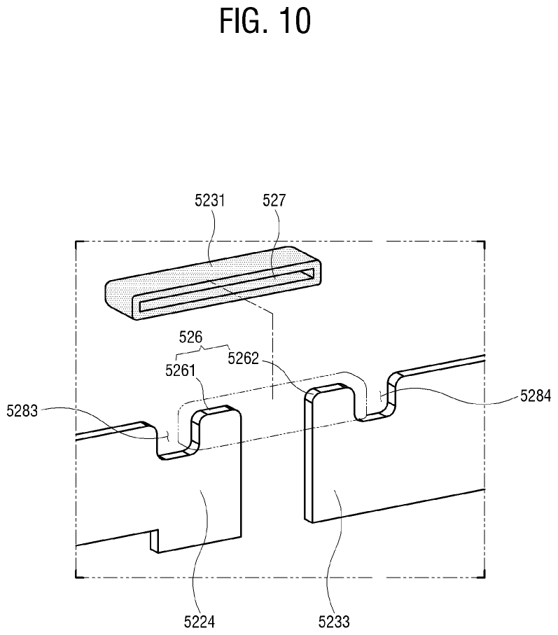

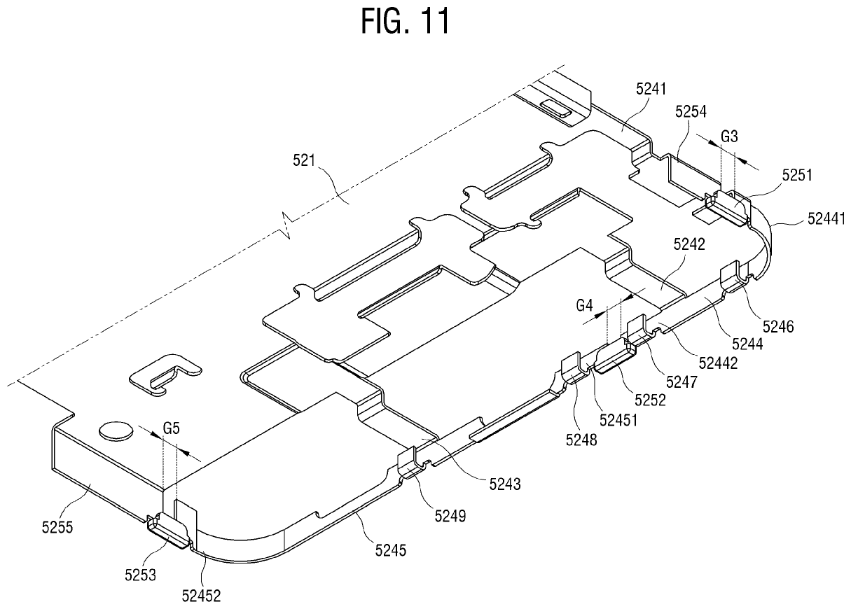

FIG. 9 is a view illustrating the first antenna assembly 522 of FIG. 3, FIG. 10 is a view illustrating a coupling structure of a first antenna radiator 5224 according to an embodiment, and FIG. 11 is a view illustrating the second antenna assembly 524 of FIG. 3.

As shown in FIG. 9, the first antenna assembly 522 may include first to third bridges 5221,5222 and 5223, first and second antenna radiators 5224 and 5225, the first to fourth contact portions 5226 to 5229, first and second connecting members 5231 and 5232, or a first antenna supporter 5233.

The first to third bridges 5221,5222 and 5223 respectively protrude from the main body 521 leftwards, upwards and rightwards, so that the first and second antenna radiators 5224 and 5225 can be extended leaving a predetermined gap from and surrounding the outer edge of the main body 521.

The first bridge 5221 is extended from the left side of the main body 521 and protrude leftwards. The first bridge 5221 may be bent from the sheet surface of the main body 521 toward the top and then extended in parallel with the sheet surface of the main body 521. The end portion of the first bridge 5221 may be provided integrally with the first antenna supporter 5233 for coupling with the free end portion of the first antenna radiator 5224 by the first connecting member 5231.

The first antenna supporter 5233 may be bent toward the top perpendicularly to the sheet surface of the first bridge 5221 and then extended to be adjacent to the free end portion of the first antenna radiator 5224 so as to hold and support the first antenna radiator 5224. The first antenna supporter 5233 may have a sheet surface in the same direction as the sheet surface of the first antenna radiator 5224.

The second bridge 5222 may be extended from the upper side of the main body 521 while protruding toward the top. The second bridge 5222 may be bent from the sheet surface of the main body 521 toward the top, and then extended in parallel with the sheet surface of the main body 521. An end portion of the second bridge 5222 may be provided integrally with the first antenna radiator 5224.

The first antenna radiator 5224 may be bent from the second bridge 5222 toward the top perpendicularly to the sheet surface of the second bridge 5222. The first antenna radiator 5224 may have a sheet surface perpendicular to the sheet surface of the main body 521. The first antenna radiator 5224 may be shaped like a cantilever, extended from the end portion of the second bridge 5222 leftwards leaving a gap along the upper side of the main body 521, and bent and extended having an arc shape toward the end portion of the first antenna supporter 5233. The free end portion of the first antenna radiator 5224 may be disposed adjacent to the end portion of the first antenna supporter 5233 with a first gap G1 therebetween.

The third bridge 5223 may be extended to protrude from the right side of the main body 521 rightwards. The third bridge 5223 may be bent from the sheet surface of the main body 521 toward the top, and then extended in parallel with the sheet surface of the main body 521. The end portion of the third bridge 5223 may be provided integrally with the second antenna radiator 5225.

The second antenna radiator 5225 may be bent from the third bridge 5223 toward the top perpendicularly to the sheet surface of the third bridge 5223. The second antenna radiator 5225 may have a sheet surface perpendicular to the sheet surface of the main body 521. The second antenna radiator 5225 may be shaped like a cantilever, bent having an arc shape from the end portion of the third bridge 5223, and extended leftwards along the upper side of the main body 521. The free end portion of the second antenna radiator 5225 may be disposed adjacent to the fixed end portion of the first antenna radiator 5224 with a second gap G2 therebetween.

The first and second contact portions 5226 and 5227 may be bent in two steps from the first antenna radiator 5224 and protrude toward the upper side of the main body 521. The first and second contact portions 5226 and 5227 may have sheet surfaces in parallel with the sheet surface of the first antenna radiator 5224.

The third and fourth contact portions 5228 and 5229 may be bent in two steps from the second antenna radiator 5225 and protrude toward the upper side of the main body 521. The third and fourth contact portions 5228 and 5229 may have sheet surfaces in parallel with the sheet surface of the second antenna radiator 5225.

As shown in FIG. 10, the first antenna radiator 5224 and the first antenna supporter 5233 may include first and second protrusions 5261 and 5262 respectively provided in the first antenna radiator 5224 and the first antenna supporter 5233 as a first coupling unit 526. The first and second protrusions 5261 and 5262 may be respectively formed by first and second groove portions 5283 and 5284 provided adjacent to the end portion of the first antenna supporter 5233 and the free end portion of the first antenna radiator 5224.

In some embodiments, at least one among the bridge, the at least one antenna radiator and the contact portion is formed by bending a strap extended outwards from the first outer edge of the main body. In some embodiments, the at least one antenna radiator is extended being bent perpendicularly to a first sheet surface of the main body. In some embodiments, the contact portion is formed by transforming a second sheet surface of the at least one antenna radiator to protrude toward the main body. In some embodiments, the contact portion protrudes from the second sheet surface of the at least one antenna radiator toward the main body and is bent to have a third sheet surface parallel to the second sheet surface of the at least one antenna radiator. See FIG. 9 and FIG. 11 (described below).

The first connecting member 5231 may include a second coupling unit 527 recessed having a cap shape. The second coupling unit 527 may include a single groove or may include two grooves respectively partitioned corresponding to the first and second protrusions 5261 and 5262.

The first connecting member 5231 may be made of a polymer-based nonmetal (nonconductive) material such as PC GF 10% or PC GF 20% (a molding temperature of 330 degrees) when the material of the outer casing 51 is PC GF 10%. The first connecting member 5231 may be made of a Teflon-based nonmetal (nonconductive) material.

The first connecting member 5231 may be fixed and coupled by forcibly fitting a coupling groove 5271 to the first and second protrusions 5261 and 5262. The coupling between the first antenna supporter 5233 and the first antenna radiator 5224 by the first connecting member 5231 may prevent opening due to injection during the insert-injection molding of the inner supporter 52.

Further, high temperature applied during the injection molding may melt at least a portion of the inner wall of the coupling groove 5271 being in contact with the first and second protrusions 5261 and 5262.

The structure of the first and second coupling units 526 and 527 for coupling the first antenna supporter 5233 and the first antenna radiator 5224 to each other is not limited only to the foregoing structure.

The second connecting member 5232 may connect and fix the fixed end portion of the first antenna radiator 5224 and the free end portion of the second antenna radiator 5225 to each other.

The fixed end portion of the first antenna radiator 5224 and the free end portion of the second antenna radiator 5225 may include a first coupling unit such as the first and second protrusions 5261 and 5262 as shown in FIG. 10. Further, the second connecting member 5232 may include the second coupling unit as shown in FIG. 10.

As shown in FIG. 11, the second antenna assembly 524 may include fourth to sixth bridges 5241, 5242 and 5243, third and fourth antenna radiators 5244 and 5245, the fifth to eighth contact portions 5246 to 5249, third to fifth connecting members 5251, 5252 and 5253, and second and the third antenna supporters 5254 and 5255.

The fourth bridge 5241 may be extended to protrude from the lower right side of the main body 521 downwards. The fourth bridge 5241 may be bent from the sheet surface of the main body 521 toward the top, and extended in parallel with the sheet surface of the main body 521. The end portion of the fourth bridge 5241 may be provided integrally with the second antenna supporter 5254.

The second antenna supporter 5254 may be bent toward the top perpendicularly to the sheet surface of the fourth bridge 5241 and then extended to be adjacent to a first freed end portion of the third antenna radiator 5244 so as to hold and support the third antenna radiator 5244. The second antenna supporter 5254 may have a sheet surface in the same direction as the sheet surface of the third antenna radiator 5244.

The fifth bridge 5242 may be extended to protrude from the lower side of the main body 521 downwards. The fifth bridge 5242 may be bent from the sheet surface of the main body 521 toward the top, and then extended in parallel with the sheet surface of the main body 521. The end portion of the fifth bridge 5242 may be provided integrally with the third antenna radiator 5244.

The third antenna radiator 5244 may be bent from the fifth bridge 5242 toward the top to have a sheet surface perpendicular to the sheet surface of the fifth bridge 5242. The third antenna radiator 5244 may be shaped like a cantilever, extended from the end portion of the fifth bridge 5242 rightwards leaving a gap along the lower side of the main body 521, and bent toward the right lower end of the main body 521. A first free end portion 52441 of the third antenna radiator 5244 may be disposed adjacent to the second antenna supporter 5254 with a third gap G3 therebetween.

Further, the third antenna radiator 5244 may also be extended from the end portion of the fifth bridge 5242 leftwards leaving a gap along the lower side of the main body 521. A second free end portion 52442 of the third antenna radiator 5244 may be disposed adjacent to a first free end portion 52451 of the fourth antenna radiator 5245 with a fourth gap G4 therebetween.

The sixth bridge 5243 may be extended to protrude from the lower side of the main body 521 downwards. The sixth bridge 5243 may be bent from the sheet surface of the main body 521 toward the top, and then extended in parallel with the sheet surface of the main body 521. The end portion of the sixth bridge 5243 may be provided integrally with the fourth antenna radiator 5245.

The fourth antenna radiator 5245 may be bent from the sixth bridge 5243 toward the top to have a sheet surface perpendicular to the sheet surface of the sixth bridge 5243. The fourth antenna radiator 5245 may be shaped like a cantilever, and extended from the end portion of the sixth bridge 5243 rightwards along the lower side of the main body 521. The first free end portion 52451 of the fourth antenna radiator 5245 may be disposed adjacent to the second free end portion 52442 of the third antenna radiator 5244 with the fourth gap G4 therebetween.

Further, the fourth antenna radiator 5245 may also be extended from the end portion of the sixth bridge 5243 leftwards along the lower side of the main body 521, and its second free end portion 52452 may be bent toward the left lower end of the main body 521. The second free end portion 52452 of the fourth antenna radiator 5245 may be disposed adjacent to the third antenna supporter 5255 with a fifth gap G5 therebetween.

The third antenna supporter 5255 may be bent from the left lower end of the main body 521 toward the top to have a sheet surface perpendicular to the sheet surface of the main body 521. The third antenna supporter 5255 is disposed adjacent to the second free end portion 52452 of the fourth antenna radiator 5245. The third antenna supporter 5255 may have a sheet surface in the same direction as the sheet surface of the fourth antenna radiator 5245.

The fifth and sixth contact portions 5246 and 5247 may be bent in two steps from the third antenna radiator 5244 and protrude toward the lower side of the main body 521. The fifth and sixth contact portions 5246 and 5247 may have sheet surfaces in parallel with the sheet surface of the third antenna radiator 5244.

The seventh and eighth contact portions 5248 and 5249 may be bent in two steps from the fourth antenna radiator 5245 and protrude toward the lower side of the main body 521. The seventh and eighth contact portions 5248 and 5249 may have sheet surfaces in parallel with the sheet surface of the fourth antenna radiator 5245.

The third connecting member 5251 may connect and fix the second antenna supporter 5253 and the first free end portion 52441 of the third antenna radiator 5244 to each other.

The fourth connecting member 5252 may connect and fix the second free end portion 52442 of the third antenna radiator 5244 and the first free end portion 52451 of the fourth antenna radiator 5245 to each other.

The fifth connecting member 5253 may connect and fix the second free end portion 52452 of the fourth antenna radiator 5245 and the third antenna supporter 5255 to each other.

The third to fifth connecting members 5251, 5252, and 5253 may have the second coupling units like the first connecting member 5231 shown in FIG. 10. Likewise, the second antenna supporter 5254 and the third antenna radiator 5244, the third antenna radiator 5244 and the fourth antenna radiator 5245, and the fourth antenna radiator 5245 and the third antenna supporter 5255, which are respectively connected and fixed by the third to fifth connecting members 5251, 5252 and 5253, may have the first coupling unit like the first and second protrusions 5261 and 5262 shown in FIG. 10.

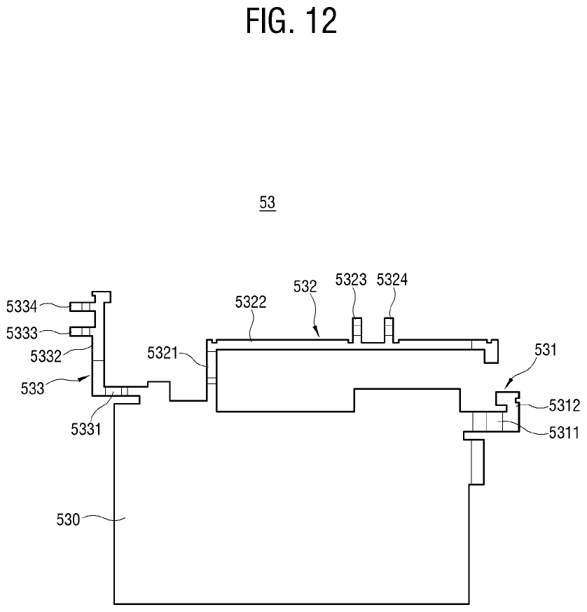

Below, a process of manufacturing the inner supporter 52 will be described with reference to FIGS. 12 to 14.

As shown in FIGS. 12 to 14, first to third straps 531 to 533 are bent in multi steps toward the bottom, and serve as the first antenna assembly 522 of FIG. 9 when flipped after completely manufactured.

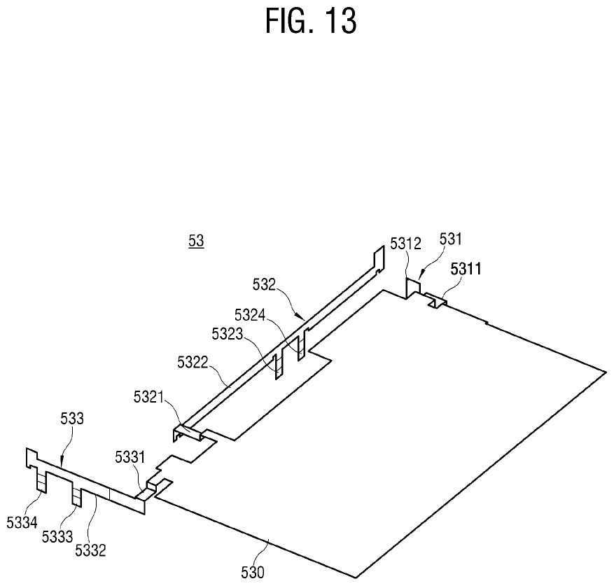

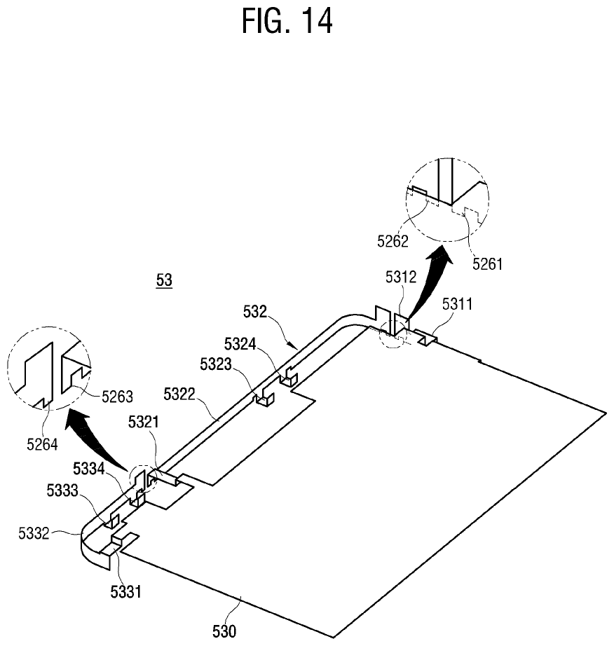

FIG. 12 is a view illustrating an unfolded sheet 53 for forming the first antenna assembly 522 according to an embodiment, FIG. 13 is a view illustrating a state that the unfolded sheet 53 of FIG. 12 is first bent according to an embodiment, and FIG. 14 is a view illustrating the first antenna assembly 522 formed by second bending from the state of FIG. 13.

As shown in FIG. 12, the unfolded sheet 53 refers to a state that the first antenna assembly 522 (see FIG. 9) bent in multiple steps is unfolded.

The unfolded sheet 53 may include a main body sheet 530 or first to third strap 531 to 533.

The main body sheet 530 may be subjected to rolling and punching to be formed as the main body 521 of the inner supporter 52.

The first strap 531 may include a first bridge strap 5311 formed as the first bridge 5221 by multiple bending, and a first support strap 5312 formed as the first antenna supporter 5233.

The second strap 532 may include a second bridge strap 5321 formed as the second bridge 5222 by multiple bending, a first antenna strap 5322 formed as the first antenna radiator 5224, and first and second contact portion straps 5323 and 5324 formed as the first and second contact portions 5226 and 5227.

The third strap 533 may include a third bridge strap 5331 formed as the third bridge 5223 by multiple bending, a second antenna strap 5332 formed as the second antenna radiator 5225, and third and fourth contact portion straps 5333 and 5334 formed as the third and fourth contact portions 5228 and 5229.

As shown in FIG. 13, the first to third bridge straps 5311, 5321 and 5331 may be bent in multiple steps perpendicularly to the sheet surface of the main body sheet 530.

Further, the first antenna strap 5322 and the second antenna strap 5332 may be bent to have sheet surfaces perpendicular to the sheet surface of the main body sheet 530.

Further, the first support strap 5312 may be bent to have a sheet surface perpendicular to the sheet surface of the main body sheet 530.

As shown in FIG. 14, the first antenna strap 5322 may be bent as its free end portion is curved toward the end portion of the first support strap 5312, and the first and second contact portion straps 5323 and 5324 may be bent to protrude toward to the upper side of the main body sheet 530. Further, the second antenna strap 5332 may be bent from the end portion of the third bridge strap 5331 toward the fixed end portion of the first antenna strap 5322, and the third and fourth contact portion straps 5333 and 5334 may be bent to protrude toward the upper side of the main body sheet 530.

The first support strap 5312 may include the first protrusion 5261 at the end portion thereof. The first antenna strap 5322 may include the second protrusion 5262 at the free end portion thereof.

The first antenna strap 5322 may include a third protrusion 5263 at the fixed end portion thereof. The second antenna strap 5332 may include a fourth protrusion 5264 at the free end portion thereof.

As described above, the first antenna supporter 5233, the first antenna radiator 5224, and the second antenna radiator 5225 of the first antenna assembly 522 may be formed by multiple-pressing the first to third straps 531, 532 and 533 of the unfolded sheet 53 shaped like a plate.

The first and second protrusions 5261 and 5262 may be fixed and coupled by the first connecting member 5231, and the third and fourth protrusions 5263 and 5264 may be fixed and coupled by the second connecting member 5232.

Meanwhile, a process of manufacturing the second antenna assembly 524 is similar to that of the first antenna assembly 522, and thus repetitive descriptions thereof will be avoided.

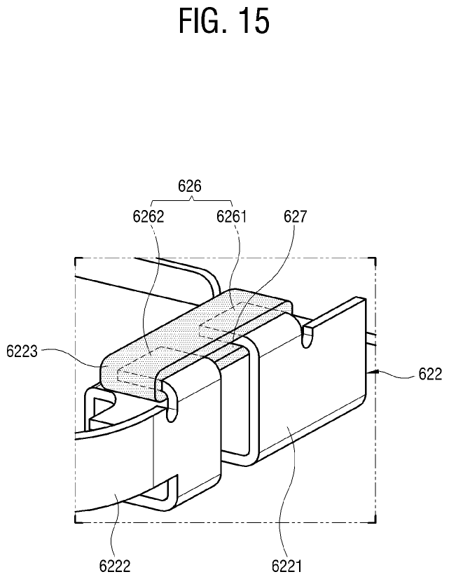

FIG. 15 is a view illustrating a coupling structure of an antenna radiator according to an embodiment.

An antenna assembly 622 may include an antenna supporter 6221 and an antenna radiator 6222 facing each other with a predetermined gap therebetween, and a connecting member 6223.

The antenna radiator 6222 and the antenna supporter 6221 may respectively include a second protrusion 6262 and a first protrusion 6261 as a first coupling unit 626 for fixing and coupling the antenna radiator 6222 to the antenna supporter 6221. The first protrusion 6261 and the second protrusion 6262 may be respectively bent from the upper sides of the antenna supporter 6221 and the antenna radiator 6222 and protrude toward the inward front.

The connecting member 6223 may include a second coupling unit 627 recessed to accommodate the first and second protrusions 6261 and 6262 to fix and couple the antenna radiator 6222 to the antenna supporter 6221.

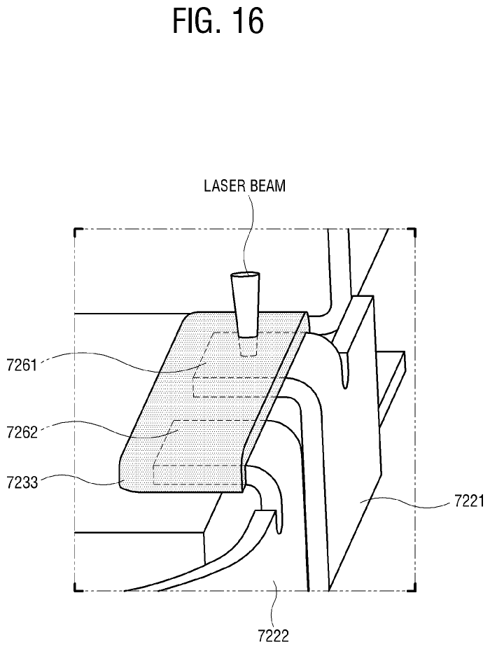

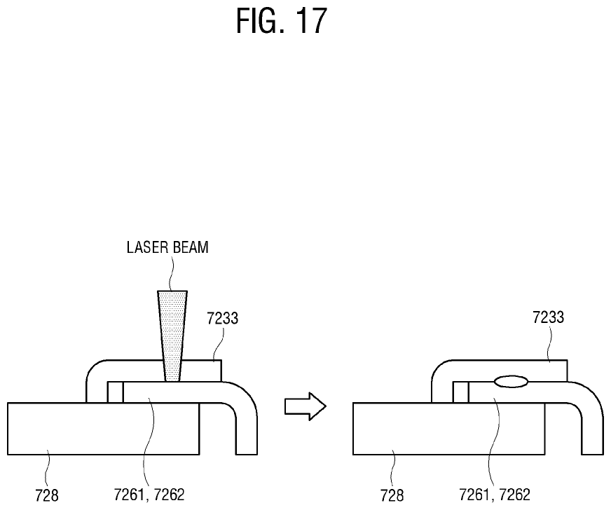

FIG. 16 is a view illustrating a bonding structure of an antenna radiator according to an embodiment, and FIG. 17 is a cross-sectional view of describing a laser bonding process for a connecting member 7233 of FIG. 16 according to an embodiment.

As shown in FIG. 16, an antenna supporter 7221 and an antenna radiator 7222 facing each other with a predetermined gap therebetween may respectively include a first protrusion 7261 and a second protrusion 7262 bent and protruding toward the front in parallel with each other.

The connecting member 7233 may be made of a transparent or translucent polymer-based resin through which a laser beam can pass.

As shown in FIG. 17, the connecting member 7233 is put on the first protrusion 7261 and the second protrusion 7262, and a seat jig 728 is disposed beneath the first protrusion 7261 and the second protrusion 7262. Then, when the laser beam is irradiated to the first protrusion 7261 and the second protrusion 7262 through the transparent or translucent connecting member 7233, heat is generated, thereby melting and bonding a contact portion between the connecting member 7233 and the first and second protrusions 7261 and 7262.

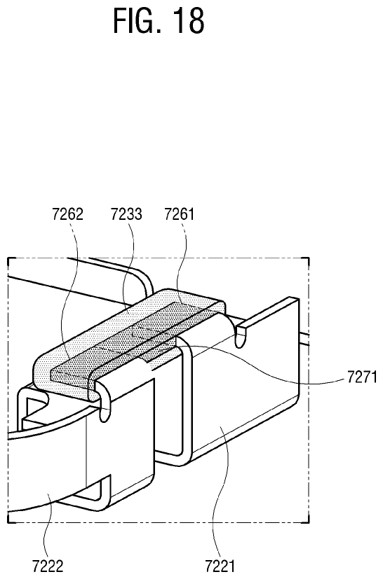

FIG. 18 is a view illustrating a coupling structure for an antenna radiator according to an embodiment.

As shown in FIG. 18, the connecting member 7233 includes a coupling groove 7271. The first protrusion 7261 and the second protrusion 7262 are inserted in the coupling groove 7271 filled with adhesive, and then the adhesive is cured, thereby bonding the connecting member 7233 to the first protrusion 7261 and the second protrusion 7262. In this case, the adhesive may include high-temperature adhesive capable of withstanding the temperature for the injection molding.

According to an embodiment, the connecting member made of resin and the antenna supporter 7221 and the antenna radiator 7222 made of metal may be bonded by a Technology Rise from Iwate (TRI) method.

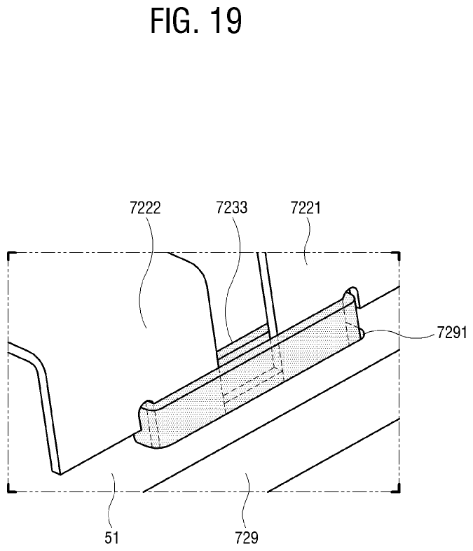

FIG. 19 is a view illustrating a state that the connecting member 7233 is applied to an insert injection mold 729 according to an embodiment.

As shown in FIG. 19, a mold 729 for the insert-injection molding of the inner supporter 52 into the outer casing 51 may include a guide groove 7291 to accommodate and support the connecting member 7233. As the connecting member 7233 is fixed and supported in the guide groove 7291 of the mold 729, the antenna radiator 7222 shaped like a cantilever and fixed by the connecting member 7233 is less affected by the injection pressure applied during the insert-injection molding and maintained in position.

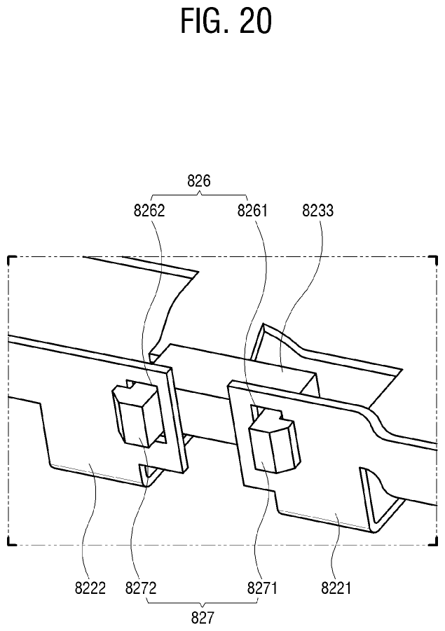

FIG. 20 is a view illustrating a coupling structure for an antenna radiator according to an embodiment.

An antenna assembly 822 may include two antenna radiators 8221 and 8222 facing each other with a predetermined gap therebetween, and a connecting member 8233 for fixing and coupling the two antenna radiators 8221 and 8222 to each other.

The two antenna radiators 8221 and 8222 respectively include a first hook holder 8261 and a second hook holder 8262 as a first coupling unit 826. The first hook holder 8261 and the second hook holder 8262 may be shaped like openings provided in the end portions of the two antenna radiators 8221 and 8222, respectively.

The connecting member 8233 may include first and second hooks 8271 and 8272 as a second coupling unit 827. The first and second hooks 8271 and 8272 may be fastened to the first hook holder 8261 and the second hook holder 8262, respectively.

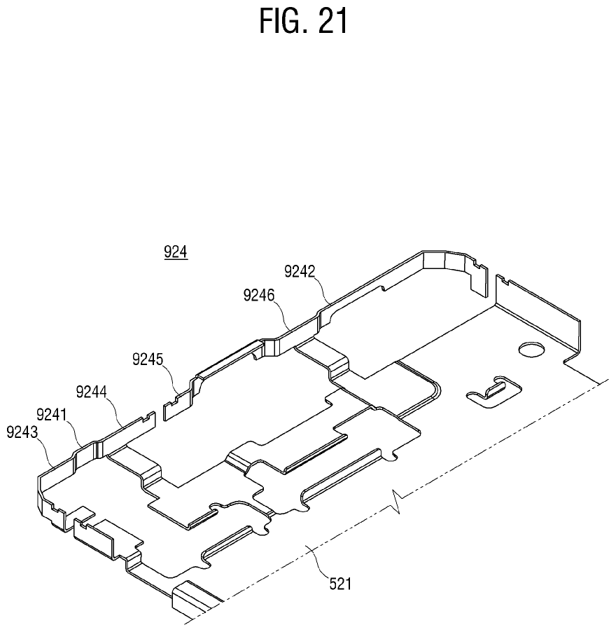

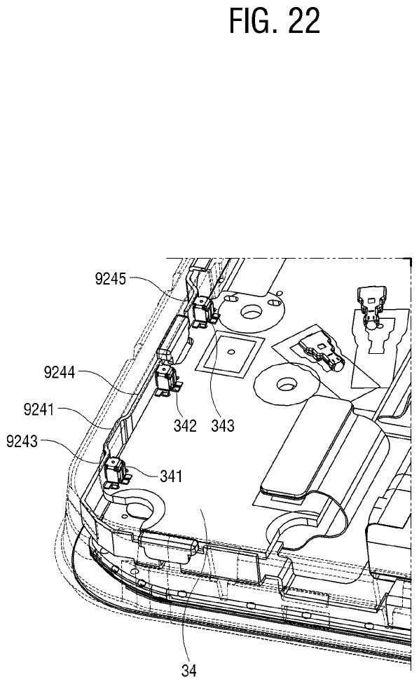

FIG. 21 is a view illustrating an antenna assembly 924 according to an embodiment, and FIG. 22 is a view illustrating a state that first to third C-clips 341 to 343 are in contact with first to third contact portions 9243 to 9245 of the antenna assembly 924 of FIG. 21.

As shown in FIG. 21, the first antenna radiator 9241 may include the first and second contact portions 9243 and 9244 of which the sheet surfaces protrude toward the main body 521. The second antenna radiator 9242 may include the third and fourth contact portion 9245 and 9246 protruding toward the main body 521. Unlike the fifth to eighth contact portions 5246 to 5249 described above with reference to FIG. 11, the first to fourth contact portions 9243 to 9246 may be formed by transforming the sheet surfaces of the first and second antenna radiators 9241 and 9242 to partially protrude.

As shown in FIG. 22, the first to third contact portions 9243 to 9245 may be in contact with the first to third C-clips 341 to 343.

According to an embodiment, the inner supporter 52 is not limited to the insert-injection molding into the outer casing 51, but may be supported by adhesion or assembly.

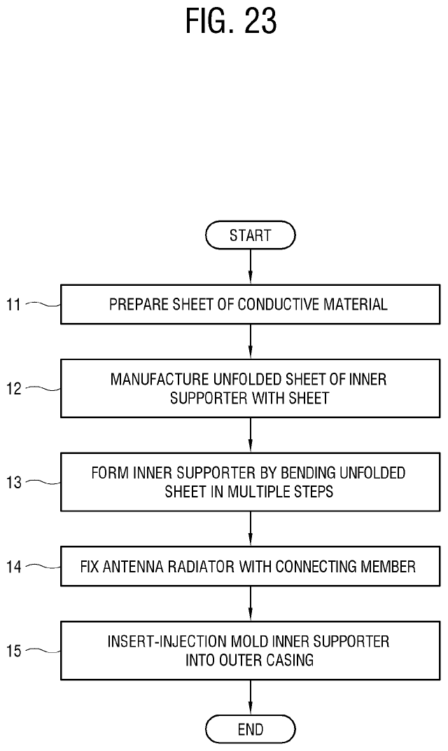

FIG. 23 is a flowchart showing a method of manufacturing the housing 50 of the electronic device 1 according to an embodiment.

At operation 11, a sheet of conductive material is prepared.

At operation 12, as shown in FIG. 12, the sheet of conductive material is cut to manufacture the unfolded sheet 53 of the inner supporter 52. The unfolded sheet 53 shown in FIG. 12 refers to a part of the whole unfolded sheet, i.e., a part of the main body 521 of the inner supporter 52 and a part corresponding to the first antenna assembly 522. The other part of the unfolded sheet 53, i.e., the other part of the main body 521 and a part corresponding to the second antenna assembly 524 may be manufactured in a similar way, and thus repetitive descriptions thereof will be avoided.

The unfolded sheet 53 may include at least one strap 531 to 533 for forming the antenna assembly 522.

At operation 13, as shown in FIGS. 13 and 14, at least one strap 531 to 533 are bent in multiple steps to form the first antenna assembly 522.

The first antenna assembly 522 formed as above may include the first to third bridges 5221, 5222 and 5223, the first and second antenna radiators 5224 and 5225, the first to fourth contact portions 5226 to 5229, or the first antenna supporter 5233 as shown in FIG. 9.

According to an embodiment, the first and second antenna radiators 5224 and 5225 may be formed by bending from the state of FIG. 13 to the state of FIG. 14.

According to an embodiment, the first to fourth contact portions 5226 to 5229 may be formed by bending separate contact portion straps 5323, 5324, 5333, and 5334 (see FIG. 13) extended to the first and second antenna radiators 5224 and 5225.

According to an embodiment, the first to fourth contact portion 9443 to 9446 may be formed by transforming the antenna radiators 8441 and 9442 to protrude toward the main body 521.

At operation 14, at least one connecting member 5231 made of a polymer-based nonmetal (nonconductive) material such as PC GF 10% or PC GF 20% (a molding temperature of 330 degrees) may be used to fix the antenna radiator 5224 to the antenna supporter 5233 when the material of the outer casing 51 is PC GF 10%.

According to an embodiment, as shown in FIG. 10, the first coupling unit 526 of the connecting member 5231 is forcibly fitted to the second coupling unit 527 of the antenna radiator 5224 and the antenna supporter 5233, thereby fixing the antenna radiator 5224.

According to an embodiment, as shown in FIG. 16, the connecting member 7233 made of a transparent material is disposed on the antenna supporter 7221 and the antenna radiator 7222, and then irradiated with a laser beam, thereby fixing the antenna radiator 7222.

According to an embodiment, as shown in FIG. 18, the adhesive is used to bond the connecting member 7233 to the antenna supporter 7221 and the antenna radiator 7222, thereby fixing the antenna radiator 7222.

According to an embodiment, as shown in FIG. 20, the hooks 8271 and 8272 provided in the connecting member 8233 are fastened to the hook holders 8261 and 8262 provided in the antenna supporter 8221 and the antenna radiator 8222, thereby fixing the antenna radiator 7222.

With the foregoing operations 11 to 14, the inner supporter 52 is manufactured.

At operation 15, the inner supporter 52 completed in the preceding operation is fixed into the mold for the outer casing 51, and then the polymer-based nonmetal material such as PC GF 10% is subjected to the insert-injection molding. In this case, due to high temperature applied during the insert-injection molding of the inner supporter 52 into the outer casing 51, bonding force is provided to the contact portion between the connecting member and the antenna radiator.

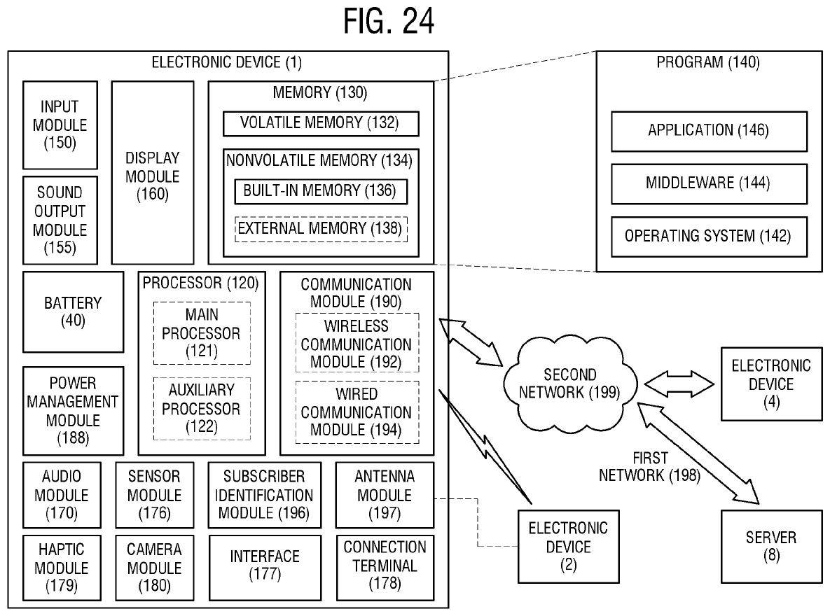

FIG. 24 is a block diagram of an electronic device 1 in a network environment according to embodiment. Referring to FIG. 24, in a network environment, an electronic device 1 may communicate with an electronic device 2 through a first network 198 (e.g., a short-range wireless communication network), or communicate with at least one of an electronic device 4 or a server 8 through a second network 199 (e.g., a long-range wireless communication network). According to an embodiment, the electronic device 1 may communicate with the electronic device 4 with the server 8. According to an embodiment, the electronic device 1 may include a processor 120, a memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module 196, or an antenna module 197. In some embodiments, the electronic device 1 may exclude at least one (e.g., the connection terminal 178) of these elements, or may additionally include one or more other elements. In some embodiments, some (e.g., the sensor module 176, the camera module 180, or the antenna module 197) of these elements may be integrated into a single element (e.g., the display module 160).

The processor 120 may for example execute software (e.g., a program 140) to control at least one of other elements (e.g., hardware or software elements) of the electronic device 1 connected to the processor 120, and to perform various data processes or operations. According to an embodiment, as at least a part of the data process or operation, the processor 120 may store an instruction or data received from other elements (e.g., the sensor module 176 or the communication module 190) in a volatile memory 132, process the instruction or data stored in the volatile memory 132, and store data of processing results in a nonvolatile memory 134. According to an embodiment, the processor 120 may include a main processor 121 (e.g., a central processing unit or an application processor), or may include an auxiliary processor 122 (e.g., a graphic processing unit, a neural processing unit (NPU), an image signal processor, a sensor hub processor, or a communication processor) independently or with the main processor 121. For example, when the electronic device 101 includes both the main processor 121 and the auxiliary processor 122, the auxiliary processor 122 may be set to use less power than the main processor 121 or to specialize in a designated function. The auxiliary processor 122 may be embodied separately from or as a part of the main processor 121.

The auxiliary processor 122 may for example control at least a part of functions or states related to at least one element (e.g., the display module 160, the sensor module 176 or the communication module 190) among the elements of the electronic device 1, instead of the main processor 121 while the main processor 121 is inactive (e.g., sleep), or with the main processor 121 while the main processor 121 is active (e.g., to execute an application). According to an embodiment, the auxiliary processor 122 (e.g., the image signal processor or the communication processor) may be embodied as a part of other functionally-related elements (e.g., the camera module 180 or the communication module 190). According to an embodiment, the auxiliary processor 122 (e.g., the NPU) may include a hardware structure that specialize in processing an artificial intelligence (AI) model. The AI model may be created through machine learning. Such learning may for example be performed in the electronic device 1 itself on which the AI model is processed, or may be performed through a separate server (e.g., the server 8). The learning algorithm may for example include but not be limited to supervised learning, unsupervised learning, semi-supervised learning, or reinforcement learning. The AI model may include a plurality of artificial neural network layers. The artificial neural network may include but be not limited to a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or one of two or more combinations thereof. Besides the hardware structure, the AI model may additionally or alternatively include a software structure.

The memory 130 may be configured to store various pieces of data to be used for at least one element (e.g., the processor 120 or the sensor module 176) of the electronic device 1. The data may for example include software (e.g., the program 140), input data or output data with regard to an instruction related to the software. The memory 130 may include the volatile memory 132 or the nonvolatile memory 134. The nonvolatile memory 134 may include a built-in memory 136 or a external memory 138.

The program 140 may be stored as software in the memory 130, and may for example include an operating system 142, a middleware 144 or an application 146.

The input module 150 may receive the instruction or data to be used for the element (e.g., the processor 120) of the electronic device 1 from the outside (e.g., a user) of the electronic device 1. The input module 150 may for example include a microphone, a mouse, a keyboard, a key (e.g., a button), or a digital pen (e.g., a stylus pen).

The sound output module 155 may output a sound signal to the outside of the electronic device 101. The sound output module 155 may for example include a loudspeaker or a receiver. The loudspeaker may be used for general purposes such as multimedia reproduction, or recording reproduction. The receiver may be used for receiving an incoming call. According to an embodiment, the receiver may be embodied separately from or as a part of the loudspeaker.

The display module 160 may visually provide information to the outside (e.g., a user) of the electronic device 1. The display module 160 may for example include a display, a hologram device or a projector, and a control circuit for controlling the corresponding device. According to an embodiment, the display module 160 may include a touch sensor set to detect a touch, or a pressure sensor set to measure the strength of force caused by the touch.

The audio module 170 may convert a sound into an electric signal or may reversely convert an electric signal into a sound. According to an embodiment, the audio module 170 may obtain a sound through the input module 150, or output a sound through the sound output module 155, or an external electronic device (e.g., the electronic device 2, the loudspeaker or a headphone) directly or wirelessly connected to the electronic device 1.

The sensor module 176 may detect the operating state of the electronic device 1 (e.g., power or temperature) or the state of an external environment (e.g., a user condition), and generate an electric signal or data value corresponding to the detected state. According to an embodiment, the sensor module 176 may for example include a gesture sensor, a gyro sensor, a barometer, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more designated protocols to be used by the electronic device 1 to be directly or wirelessly connected to the external electronic device (e.g., the electronic device 2). According to an embodiment, the interface 177 may for example include a high-definition multimedia interface (HDMI), a universal serial bus (USB) interface, a secured digital (SD) card interface, or an audio interface.

The connection terminal 178 may include a connector by which the electronic device 1 is physically connectable to the external electronic device (e.g., the electronic device 2). According to an embodiment, the connection terminal 178 may for example include an HDMI connector, a USB connector, an SD card connector, or an audio connector (e.g., a headphone connector).

The haptic module 179 may convert an electric signal into a mechanical stimulus (e.g., vibration or movement) or an electric stimulus to be recognized by a user through tactile or kinesthetic senses. According to an embodiment, the haptic module 179 may for example include a motor, a piezoelectric device, or an electro-stimulator.

The camera module 180 may be configured to take a still image or a moving image. According to an embodiment, the camera module 180 may include one or more lenses, image sensors, image signal processors, or flashes.

The power management module 188 may be configured to manage power supplied to the electronic device 1. According to an embodiment, the power management module 188 may for example be embodied as at least a part of a power management integrated circuit (PMIC).

The battery 40 may supply power to at least one element of the electronic device 1. According to an embodiment, the battery 40 may for example include a non-rechargeable primary cell, a rechargeable secondary cell, or a fuel cell.

The communication module 190 may establish a direct (e.g., wired) communication channel or wireless communication channel between the electronic device 1 and the external electronic device (e.g., the electronic device 2, the electronic device 4, or the server 8), and support communication based on the established communication channel. The communication module 190 may operate independently of the processor 120 (e.g., the application processor), and include one or more communication processors to support the direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power-line communication module). Among these communication modules, the corresponding communication module may communicate with the external electronic device 4 through the first network 198 (e.g., Bluetooth, Wi-Fi direct or infrared data association (IrDA) or the like short-range communication network) or the second network 199 (e.g., a legacy cellular network, a 5G network, a next-generation communication network, the Internet, a computer network (e.g., LAN or a wide area network (WAN)), or the like long-range communication network). Such various kinds of communication modules may be integrated into one element (e.g., a single chip), or a plurality of element (e.g., a plurality of chips) separated from one another. The wireless communication module 192 may use subscriber information (e.g., international mobile subscriber identity (IMSI)) stored in the subscriber identification module 196 to identify or authenticate the electronic device 1 in the communication network such as the first network 198 or the second network 199.

The wireless communication module 192 may support a 5G network and the next-generation communication technology, for example, new radio (NR) access technology, after the 4G network. The NR access technology may support high-speed transmission of high-capacity data (enhanced mobile broadband (eMBB)), minimization of terminal power and access of multiple terminals (massive machine type communications (mMTC)), or ultra-reliable and low-latency communications (URLLC). The wireless communication module 192 may for example support a high frequency band (e.g., an mmWave band) to achieve a high data-transmission rate. The wireless communication module 192 may support various technologies for securing performance in a high frequency band, for example, beamforming, massive multiple-input and multiple-output (MIMO), full dimensional MIMO (FD-MIMO), an array antenna, analog beam-forming, a large-scale antenna, or the like technologies. The wireless communication module 92 may support various requirements stipulated in the electronic device 1, the external electronic device (e.g., the electronic device 4) or the network system (e.g., the second network 199). According to an embodiment, the wireless communication module 192 may support a peak data rate (e.g., higher than or equal to 20 Gbps) for the eMBB, loss coverage (e.g., lower than or equal to 164 dB) for the mMTC, or U-plane latency (e.g., lower than or equal to 0.5 ms at downlink (DL) and uplink (UL), or lower than or equal to 1 ms at a round trip) for the URLLC.

The antenna module 197 may be configured to transmit or receive a signal or power to the outside (e.g., the external electronic device) or from the outside. According to an embodiment, the antenna module 197 may include a first antenna assembly 522 and a second antenna assembly 524 provided to be integrally extended from the inner supporter 52 of the conductive material forming the housing 50. According to an embodiment, the antenna module 197 may include an antenna with an emitter provided as a conductor or conductive pattern formed on a substrate (e.g., a printed circuit board (PCB)). According to an embodiment, the antenna module 197 may include a plurality of antennas (e.g., an array antenna). In this case, at least one antenna suitable for communication used in the first network 198, the second network 199 or the like communication network may for example be selected by the communication module 190 among the plurality of antennas. The signal or power may be transmitted or received between the communication module 190 and the external electronic device through at least one antenna selected as above. According to some embodiments, besides the emitter, another element (e.g., a radio frequency integrated circuit (RFIC)) may be additionally formed as a part of the antenna module 197. According to an embodiment, the antenna module 197 may form an mmWave antenna module. According to an embodiment, the mmWave antenna module may include the RFIC disposed on or adjacent to a PCB, on a first surface (e.g., on a bottom surface) of the PCB and capable of supporting a designated high-frequency band (e.g., the mmWave band), and a plurality of antennas (e.g., the array antenna) disposed on or adjacent to a second surface (e.g., on a top or lateral surface) of the PCB and capable of transmitting or receiving a signal in the designated high-frequency band.

At least some among the elements may be connected to each other through a communication method between peripheral units (e.g., a bus, a general-purpose input and output (GPIO)), a serial peripheral interface (SPI), or a mobile industry processor interface (MIPI)), and exchange a signal (e.g., the instruction or data) to each other.

According to an embodiment, the instruction or data may be transmitted or received between the electronic device 1 and the external electronic device 4 through the server 8 connected to the second network 199. Each external electronic device 2 or 4 may be the same or different type of apparatus as the electronic device 1. According to an embodiment, all or some operations performed in the electronic device 1 may be performed in one or more external electronic devices among the external electronic devices 2, 4 or 8. For example, when the electronic device 1 needs to perform a certain function or service automatically or in response to a request from a user or another apparatus, the electronic device 1 may request one or more external electronic devices to execute at least a part of the function or service instead of or in addition to execution of the function or service in itself. One or more external electronic devices, which have received the request, may execute at least a part of the requested function or service, or an additional function or service related to the request, and transmit a result of the execution to the electronic device 1. The electronic device 1 may provide the result as it is or as it is additionally processed, as at least a part of response to the request. To this end, there may be used computing technologies, for example, cloud computing, distributed computing, mobile edge computing (MEC), or client-server computing. The electronic device 1 may for example employ the distributed computing or the MEC to provide an ultra-low latency service. According to another embodiment, the external electronic device 4 may employ an Internet of things (IoT) device. The server 8 may include an intelligent server based on the machine learning and/or neural network. According to an embodiment, the external electronic device 4 or the server 8 may be included in the second network 199. The electronic device 1 may be applied to an intelligent service (e.g., a smart home, a smart city, a smart car, or health care) based on the 5G communication technology and IoT-related technology.

Although exemplary embodiments of the disclosure have been shown and described, the disclosure is not limited to the foregoing specific embodiments, various alternative modifications can be embodied by a person having an ordinary skill in the art without departing from the scope of the disclosure as claimed in the appended claims, and such modified embodiments should not be understood separately from the technical sprit or prospect of the disclosure.

1. An electronic device comprising:
a communication module;
a printed circuit board (PCB) provided with the communication module; and
a housing supporting the PCB, and comprising an inner supporter made of a conductive material and an outer casing supporting the inner supporter,
the inner supporter comprising:
a main body made of a conductive sheet,
a bridge extended from a first outer edge of the main body in a certain direction,
at least one antenna radiator extended from the bridge along a second outer edge of the housing,
a contact portion provided from the at least one antenna radiator and facing toward an inside of the housing, and
a connecting member made of a non-conductive material and fixing the at least one antenna radiator.

2. The electronic device of claim 1, wherein at least one among the bridge, the at least one antenna radiator and the contact portion is formed by bending a strap extended outwards from the first outer edge of the main body.

3. The electronic device of claim 2, wherein the at least one antenna radiator is extended being bent perpendicularly to a first sheet surface of the main body.

4. The electronic device of claim 3, wherein the contact portion is formed by transforming a second sheet surface of the at least one antenna radiator to protrude toward the main body.

5. The electronic device of claim 4, wherein the contact portion protrudes from the second sheet surface of the at least one antenna radiator toward the main body and is bent to have a third sheet surface parallel to the second sheet surface of the at least one antenna radiator.

6. The electronic device of claim 1, wherein
the at least one antenna radiator comprises two or more antenna radiators,
each of the two or more antenna radiators is provided with a first coupling unit, and
the connecting member comprises a second coupling unit coupled to the first coupling unit.

7. The electronic device of claim 6, wherein the first coupling unit is fused to the second coupling unit in a process of insert-injection molding the inner supporter into the outer casing.

8. The electronic device of claim 6, wherein one of the first coupling unit and the second coupling unit comprises a pair of protrusions spaced apart from each other, and the other one of the first coupling unit and the second coupling unit comprises a coupling groove to accommodate the pair of protrusions by forcible fitting.

9. The electronic device of claim 6, wherein one of the first coupling unit and the second coupling unit comprises a hook, and the other one of the first coupling unit and the second coupling unit comprises a hook holder to which the hook is hooked.

10. The electronic device of claim 6, wherein
the connecting member is made of a transparent material, and
the first coupling unit is fused to the second coupling unit by a laser.

11. The electronic device of claim 6, wherein
the first coupling unit is bonded to the second coupling unit by adhesive.

12. An electronic device comprising:
a housing comprising an inner supporter made of a conductive material and an outer casing supporting the inner supporter,
the inner supporter comprising:
a main body made of a conductive sheet,
a bridge extended from a first outer edge of the main body in a certain direction,
at least one antenna radiator extended from the bridge along a second outer edge of the housing,
a contact portion provided from the at least one antenna radiator and facing toward an inside of the housing, and
a connecting member made of a non-conductive material and fixing the at least one antenna radiator.

13. A method of manufacturing an electronic device, the method comprising:
manufacturing an inner supporter made of a conductive material; and
manufacturing a housing by an insert-injection molding of the inner supporter into an outer casing made of an insulating material,
the manufacturing the inner supporter comprising:
preparing a sheet of conductive material,
manufacturing an unfolded sheet of the inner supporter on the sheet, wherein the unfolded sheet comprises a main body sheet and at least one strap extended outwards from the main body sheet, and
forming at least one antenna assembly by bending the at least one strap in multiple steps.

14. The method of claim 13, wherein the at least one strap comprises an antenna strap.

15. The method of claim 14, wherein
the at least one strap comprises a contact portion strap extended from the antenna strap, and
the method further comprises forming a contact portion to have a second sheet surface perpendicular to a first sheet surface of the main body sheet by bending the contact portion strap to protrude toward the main body sheet.
